(19) United States
(12) Patent Application Publication
(10) Pub. No.: US 2014/0091063 A1
(43) Pub. Date: Apr. 3, 2014

(54) SYSTEM FOR HARDENING A CYLINDRICAL METAL COMPONENT

(71) Applicant: ELECTRO-MOTIVE DIESEL, INC., LaGrange, IL (US)

(72) Inventors: Farhan DEVANI, Morton Grove, IL (US); Aaron Gamache FOEGE, Westmont, IL (US)

(73) Assignee: ELECTRO-MOTIVE DIESEL, INC., LaGrange, IL (US)

(21) Appl. No.: 13/629,810

(22) Filed: Sep. 28, 2012

(51) Int. Cl. B23K 31/00

(52) U.S. Cl. 219/59.1

(57) ABSTRACT

A system for hardening a cylindrical metal component is disclosed. The system may include a current generating device configured to pass current through the cylindrical metal component, and an actuator configured to axially move the current generating device through the cylindrical metal component. The system may also include a controller in communication with the current generating device and the actuator, the controller being configured to cause the current generating device to pass current through a first end section of the cylindrical metal component to heat the first end section of the cylindrical metal component. The controller may also be configured to inhibit the current generating device from passing current through a middle section of the cylindrical metal component, and cause the current generating device to pass current through a second end section of the cylindrical metal component to heat the second end section of the cylindrical metal component.

### TECHNICAL FIELD

The present disclosure relates generally to a hardening system, more particularly, to a system for hardening a cylindrical metal component.

### BACKGROUND

Machine components such as cylinder liners, shafts, gears, splined shaves, springs and sprockets are frequently subjected to high pressures, torque loads, frictional wear and impact loading. A common method of enhancing both the reliability and longevity of such components is the induction hardening process. Induction hardening is a form of heat treatment wherein a metal component is heated by electromagnetic induction and then quenched. The heated and quenched metal component undergoes what is known as a Martensitic transformation where the hardness and brittleness of the metal component is increased. Induction hardening may be used to selectively harden particular areas of a metal component without necessarily affecting the properties of the component as a whole.

Induction hardening is performed by passing an alternating current through an induction coil that is put in proximity to the metal component to be hardened. The rapidly alternating electric field causes the metal component to heat rapidly due to eddy currents and hysteresis. The depth of the resulting hardness of the metal component is controlled by varying the power level and frequency of the alternating current and travel speed of the induction coil.

Another method of hardening metal components includes laser hardening. The absorbed radiation from a laser heats the surface of a metal component to a hardening temperature. The two types of lasers that are generally used in laser hardening are gas lasers and solid state lasers. Carbon dioxide lasers are the most frequently utilized lasers for laser hardening as they are relatively more energy efficient.

Different methods of hardening may be better for some types of metal components than for others. For example, whereas induction hardening may cause deformations or melt of smaller features and openings of metal components, laser hardening may harden smaller features and openings in metal components without causing deformations. However, laser hardening may generally be a more costly and time consuming method. In some cases, a combination of induction and laser hardening may be beneficial.

One attempt to combine induction hardening and laser hardening is described in U.S. Pat. No. 7,162,798 to Mitchell K. Westra (“Westra”) that issued on Jan. 16, 2007. Westra discloses a cylinder liner that has an upper bore portion that has been fully induction hardened to improve wear resistance, and a port area (middle section) that is fully laser hardened to improve wear resistance. Westra discloses that by laser hardening the intake port area a scuff resistant hardened surface is achieved without significant distortion of the cast iron cylinder body and its previously machined surfaces. Westra aims to eliminate gaps of unhardened cylinder liner in between the two different methods of hardening by directing the laser hardening to overlap the induction hardening area of the upper bore.

Although the combined induction and laser hardening method of Westra may help to reduce cylinder liner friction and wear by hardening the upper and middle portions of the cylinder liner, its benefit may be limited. This is because the method disclosed in Westra does not account for hardening of a lower portion of the cylinder liner. Furthermore, the process of Westra is not automated making it difficult to achieve consistent results in a timely manner.

The hardening system of the present disclosure solves one or more of the problems set forth above and/or other problems in the art.

### SUMMARY

In one aspect, the present disclosure is directed to a system for hardening a cylindrical metal component. The system may include a current generating device configured to induce current through the cylindrical metal component in an annular direction to heat the cylindrical metal component, and an actuator configured to axially move the current generating device through the cylindrical metal component. The system may also include a controller in communication with the current generating device and the actuator, the controller being configured to cause the actuator to move the current generating device through the cylindrical metal component in a generally continuous manner, and cause the current generating device to pass current through a first end section of the cylindrical metal component to heat the first end section of the cylindrical metal component above a desired first hardening temperature as the current generating device moves through the first end section of the cylindrical metal component. The controller may also be configured to inhibit the current generating device from passing current through a middle section of the cylindrical metal component as the current generating device moves through the middle section of the cylindrical metal component, and cause the current generating device to pass current through a second end section opposite the first end section of the cylindrical metal component to heat the second end section of the cylindrical metal component above a desired second hardening temperature as the current generating device moves through the second end section of the cylindrical metal component.

In another aspect, the present disclosure is directed to a method of hardening a cylindrical metal component. The method may include directing a current generating device axially through the cylindrical metal component in a generally continuous manner, and causing the current generating device to pass current through the cylindrical metal component as the current generating device moves axially through a first end section of the cylindrical metal component to heat the first end section above a desired first hardening temperature. The method may also include inhibiting the current generating device from passing current through the cylindrical metal component as the current generating device moves axially through a middle section of the cylindrical metal component, and cause the current generating device to pass current through the cylindrical metal component as the current generating device moves axially through a second end section of the cylindrical metal component to heat the second end section above a desired second hardening temperature.

### BRIEF DESCRIPTION OF THE DRAWINGS

FIG. 1 is a cut-away illustration of an exemplary disclosed engine;

FIG. 2 is a cross-sectional view of an exemplary disclosed cylinder liner that may be used in conjunction with the engine of FIG. 1; and

FIG. 3 is a flowchart depicting an exemplary disclosed method that may be used to harden the cylinder liner of FIG. 2.

### DETAILED DESCRIPTION

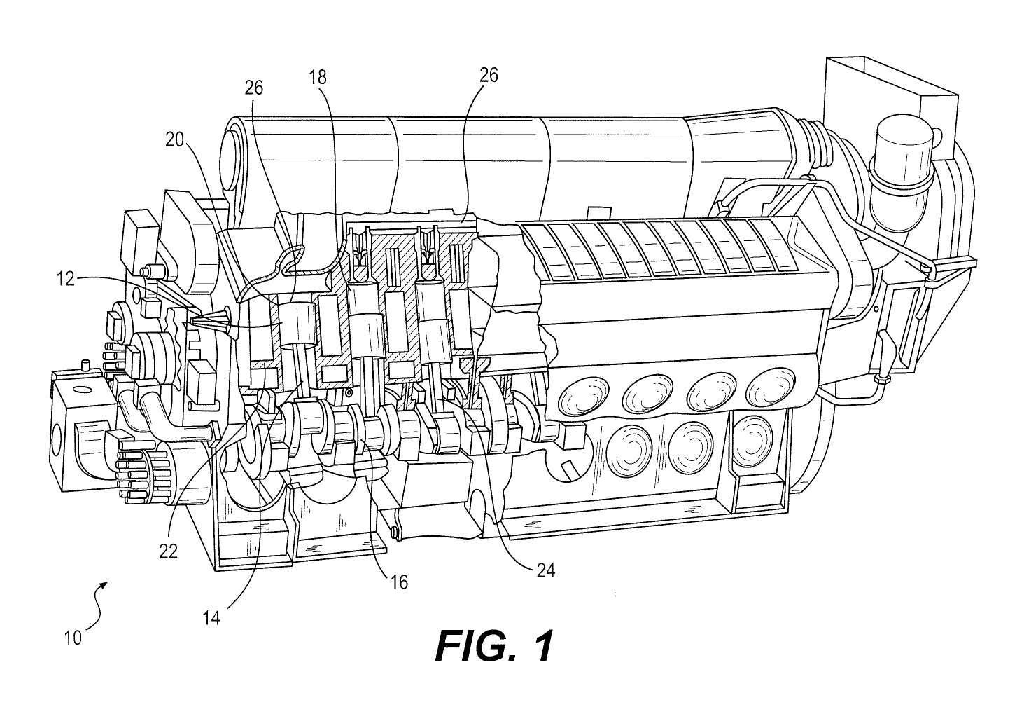

FIG. 1 illustrates an exemplary embodiment of an engine 10 that may be, for example, a diesel engine, a gasoline engine, or a gaseous fuel-powered engine. Engine 10, in this embodiment, is a two-cycle diesel engine associated with a locomotive (not shown). Engine 10 may include, among other things, an assembly of pistons 12, connecting rods 14, and a crankshaft 16. Each piston 12 may be connected to crankshaft 16 by a corresponding one of connecting rods 14, such that movement of pistons 12 results in rotation of crankshaft 16. These components may operate together to transform chemical energy in fuel into useful rotational motion of crankshaft 16 through a series of explosions within combustion chambers 18 of engine 10. These explosions may cause pistons 12 and connecting rods 14 of engine 10 to reciprocate within cylinders 20. In this manner, cylinders 20 may serve as pressure vessels in which the process of combustion takes place and as guides for pistons 12 sliding within them.

Cylinders 20 may be arranged within an engine block 22 in two banks positioned at an angle to each other. Each bank may include a group of cylinders 20 located on the same side of crankshaft 16 with their axes lying in a common plane passing through an axis of crankshaft 16. Each cylinder 20 may be sealed at its top by a cylinder head 26. Piston 12, reciprocal within cylinder 20, may thus define a variable-volume combustion chamber 18.

Cylinder 20 may be sealed at its bottom by piston 12 and a plurality of piston rings (not shown). The piston rings may help to seal off combustion chamber 18 and may be received by machined grooves defined in an outer surface of piston 12. For example, each piston 12 may have four compression rings on an upper portion to seal cylinder 20 from cylinder block 22. This arrangement may guard against combustion gases leaking past piston 12 into cylinder block 22 and may provide a means by which surplus heat may be transmitted from piston 12 to the walls of cylinder 20. Piston 12 may also have two oil control rings positioned on a lower portion to control lubrication and prevent excess oil consumption by effectively distributing the lubricating oil on the walls of cylinder 20.

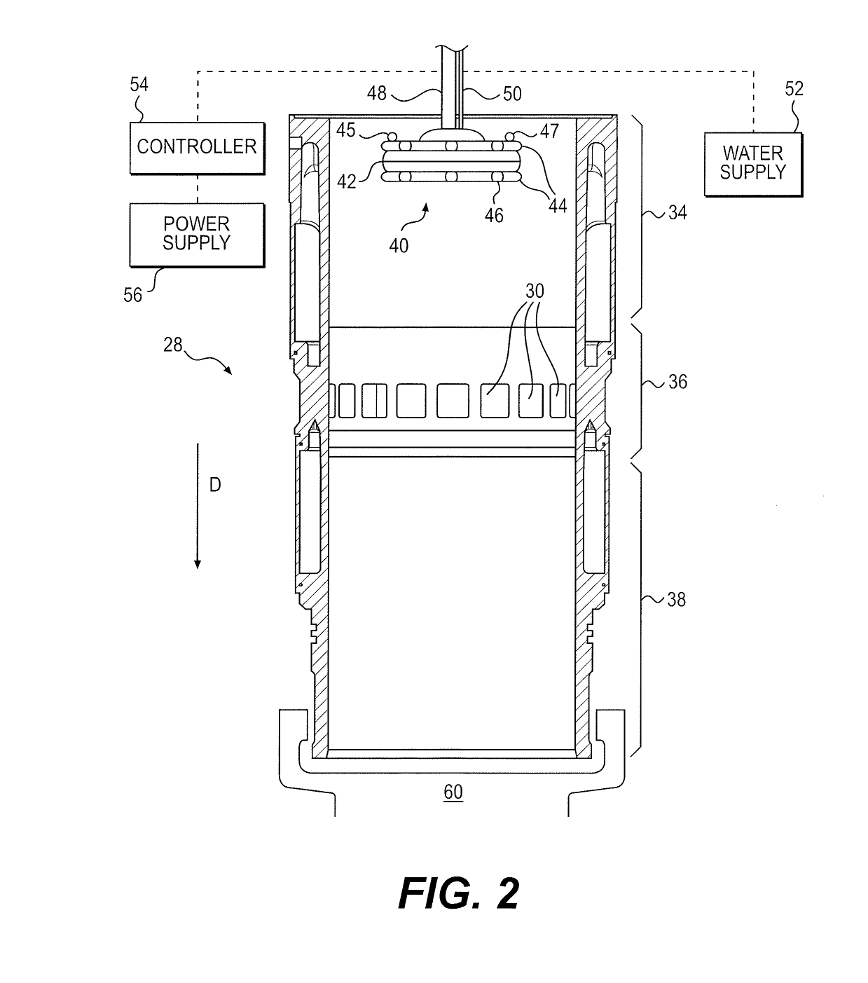

FIG. 2 illustrates a cross-sectional view of an exemplary cylinder liner 28 that may be used to protect an associated cylinder 20 from wear and degradation caused by piston 12. Cylinder liner 28 may have a generally cylindrical shape and may be removably fitted within cylinder 20 in which piston 12 reciprocates. During operation of engine 10, cylinder liner 28 may form a sliding surface for piston 12 and the piston rings as piston 12 is driven in an up-and-down reciprocating motion by connecting rod 14 and crankshaft 16.

The inner surface of cylinder liner 28 may be divided into an upper section 34, a middle section 36, and a lower section 38. Upper section 34 may be characterized by an axial length of approximately 1.5-2.5 times the axial length of middle section 36. Lower section 38 may be characterized by an axial length of approximately 2-3.5 times the axial length of middle section 36. Middle section 36 may be characterized by one or more intake ports 30 arranged around the circumference of cylinder liner 28. This arrangement may help ensure proper cylinder scavenging for engine 10, whereby fresh air for a new cycle may be introduced into cylinder 20 and rotation of crankshaft 16 may force any remaining exhaust from the previous power stroke from cylinder 20.

As piston 12 (referring to FIG. 1) and/or the piston rings reciprocate within cylinder 20, they may impart damage to cylinder liner 28 in the form of scuffing. Scuffing may occur with the formation of local microscopic welds between piston 12 and/or the piston rings and cylinder liner 28. Scuffing may also result from the piston rings dragging debris past intake ports 30 across the inner surface of cylinder liner 28. To help reduce scuffing of cylinder liner 28, the inner surface of cylinder liner 28 may be hardened.

Different portions of cylinder liner 28 may be either induction or laser hardened. Induction hardening may be accomplished by a hardening system 40. As illustrated in FIG. 2, hardening system 40 may include a current generating device (e.g. a coil) 42, coil covers 44, water nozzles 46, an input temperature sensor 45, and an input distance sensor 47. Hardening system 40 may move axially, in direction D, through cylinder liner 28 and selectively activate at various sections of cylinder liner 28.

Current generating device 42 may selectively heat cylinder liner 28 through electromagnetic induction. The varying magnetic field required for induction heating may be developed from the flow of alternating current within current generating device 42. Current generating device 42 may not come in contact with, but may be brought into relative close proximity to, cylinder liner 28 during induction heating. Coil covers 44 may cover top and bottom portions of current generating device 42, thereby providing a place for the other components of hardening system 40, including water nozzles 46. Water nozzles 46 may be configured to deliver water to the heated portion of cylinder liner 28 concurrent with or following the induction heating. In this manner, water nozzles 46 may provide the quenching aspect required to cool and control the hardening process of cylinder liner 28. Water supply 52 may distribute the water to water nozzles 46 via a water conduit 50.

Input temperature sensor 45 may be a non-contact temperature sensor or infrared temperature sensor configured to infer temperature of cylinder liner 28 during induction heating by monitoring thermal radiation emitted from cylinder liner 28. Input temperature sensor 45 may be in communication with a controller 54 and provide feedback to controller 54 during the induction heating process.

Input distance sensor 47 may be a position and/or linear sensor which may utilize an analog signal based on the distance current generating device 42 is located from a target distance. Input distance sensor 47 may operate mechanically with a transducer or an encoder or electrically with photoelectric, inductive, and ultrasonic sensors to monitor the distance hardening system 40 has moved through cylinder liner 28. Input distance sensor 47 may also monitor the distance from the radial end of current generating device 42 to the interior wall of cylinder liner 28. Input distance sensor 47 may be in communication with controller 54 and provide feedback to controller 54 during the induction heating process.

In addition to, or in the place of, input distance sensor 47 either a limit switch or contact switch may be utilized to monitor the distance current generating device 42 travels within a cylindrical metal component. In the case of a limit switch, current generating device 42 may be configured to trip the limit switch upon arrival at the limit switch. Tripping the limit switch may result in deactivation of current generating device 42. In the case of a contact switch, current generating device 42 may be in contact with a strip of conducting material. As long as current generating device 42 is in contact with the strip of conducting material current generating device 42 may be activated. As current generating device 42 travels, upon arrival at the end of the strip of conducting material, current generating device 42 may be deactivated.

As previously described, input sensors 45 and 47 may be in communication with controller 54. Controller 54 may embody a single microprocessor or multiple processors that include a means for controlling an operation of hardening system 40. Numerous commercially available microprocessors may perform the functions of controller 54. Controller 54 may include or be associated with a memory for storing data such as, for example, an operation condition, design limits, performance characteristics or specifications of operation of hardening system 40. Various other known circuits may be associated with controller 54, including power supply circuitry, and other appropriate circuitry. Moreover, controller 54 may be capable of communicating with other components of hardening system 40 via either wired or wireless transmission and, as such, controller 54 may be disposed in a location remote from hardening system 40, if desired.

Controller 54 may monitor and control the induced flow of current through cylinder liner 28. A timer (not shown) may be associated with controller 54. The timer may track the amount of time current generating device 42 is activated. Controller 54 may direct current generating device 42 to induce electrical current through cylinder liner 28 in an annular direction. Current generating device 42 may induce sufficient current to cause cylinder liner 28 to heat to a hardening temperature of between about 1,420° F. to 1,450° F. in less than about one second. Heating cylinder liner 28 to this temperature may harden cylinder liner 28 to a hardness greater than approximately 50 on the Rockwell C scale. Controller 54 may also control the timing and flow of water through nozzles 46 during the quenching process.

Upon receipt of feedback from input sensors 45 and 47 and the timer, controller 54 may adjust operation of an actuator 60 to modify movement of current generating device 42 during the induction heating process. Actuator 60 may include a lift and may be powered by an electric motor, a hydraulic motor, a pneumatic motor or any other motor known in the art. Actuator 60 may attach to an end of cylinder liner 28 and may axially elevate or lower current generating device 42 relative to cylinder liner 28. Actuator 60 may also spin cylinder liner 28 so as to achieve uniform heating and cooling of cylinder liner 28 during the induction heating process. In one embodiment, actuator 60 may move cylinder liner 28 relative to current generating device 42 under the direction of controller 54. In another embodiment, cylinder liner 28 may be stationary while current generating device 42 is moved relative to cylinder liner 28 by an actuator. Controller 54 may vary the speed at which current generating device 42 moves relative to cylinder liner 28.

Hardening system 40 may be powered by power supply 56. Power supply 56 may be any type of power supply that is capable of providing a variable supply of power, such as a battery, an AC power supply, or a DC power supply such as a linear power supply, a switching power supply, a DC-DC converter, a silicon controlled rectifier (SCR), or other type of power supply. Power supply 56 may be directly or indirectly connected to current generating device 42 and/or actuator 60 by way of controller 54. Thus, depending on a desired set of conditions, controller 54 may regulate power supply 56 to alter a polarity, a current, a voltage, and/or other parameters of the power. Power and communication lines may be routed from controller 54 to current generating device 42 via a conduit 48.

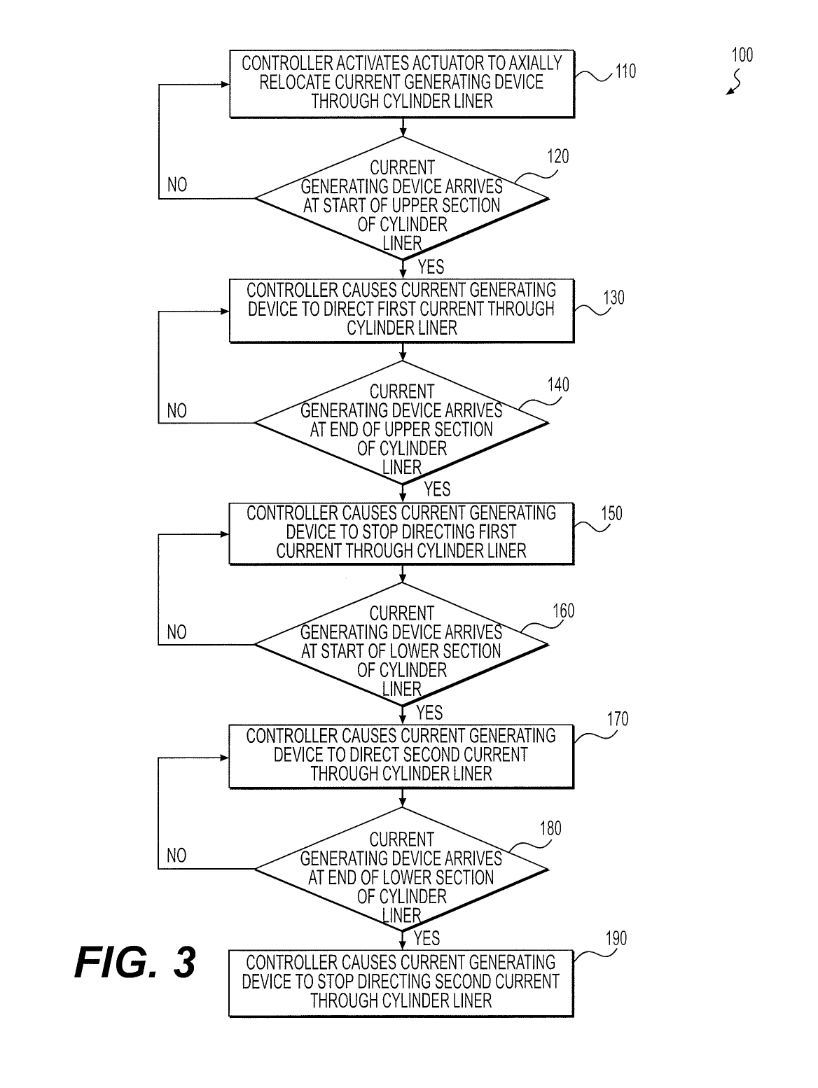

FIG. 3 illustrates an exemplary method 100 that may be used to harden cylinder liner 28. FIG. 3 will be discussed in more detail in the following section to further illustrate the disclosed concepts.

### INDUSTRIAL APPLICABILITY

The systems and methods of the present disclosure may be applicable to hardening of any cylindrical metal component. For example, the disclosed induction hardened cylinder liner may provide an efficient means to help reduce friction and wear in an engine such as, for example, a two-stroke diesel engine. In particular, the disclosed cylinder liner may help reduce the risk of scuffing that may result under the harsh pressure and temperature conditions of combustion chamber 18. The disclosed cylinder liner may be of particular application to uniflow two-stroke diesel engines that are especially vulnerable to scuffing because of particulates entering through intake ports 30 and being dragged along cylinder liner 28 during engine operation. In this regard, the disclosed cylinder liner may also beneficially help to reduce particulate emissions generally. Operation of hardening system 40 will now be described with respect to FIG. 3.

At the start of exemplary method 100 shown in FIG. 3, controller 54 may cause actuator 60 to axially move current generating device 42 through cylinder liner 28 (Step 110) in a generally continuous motion in direction D. As long as current generating device 42 does not reach the start of upper section 34 of cylinder liner 28 (Step 120—No), controller 54 may not direct current generating device 42 to direct current through cylinder liner 28. Upon arrival of current generating device 42 at the start of upper section 34 of cylinder liner 28 (Step 120—Yes), controller 54 may cause current generating device 42 to direct a first current through cylinder liner 28 (Step 130).

Current generating device 42 may heat cylinder 28 to a temperature of between about 1,420° F. to 1,450° F. in less than about one second with the first current. As current generating device 42 is relocated through cylinder liner 28 by actuator 60, and as long as current generating device 42 does not reach the end of upper section 34 of cylinder 28 (Step 140—No), controller 54 will continue to direct current generating device 42 to direct the first current through cylinder liner 28. Upon arrival of current generating device 42 at the end of upper section 34 of cylinder liner 28 (Step 140—Yes), controller 54 may cause current generating device 42 to stop directing the first current through cylinder liner 28 (Step 150).

As current generating device 42 continues to move through cylinder liner 28 in direction D, and until the current generating device 42 arrives at the start of lower section 38 of cylinder liner 28, controller 54 will not cause current generating device 42 to direct current through cylinder liner 28 (Step 160—No). Upon arrival of current generating device 42 at the start of lower section 38 of cylinder liner 28 (Step 160—Yes), controller 54 may cause current generating device 42 to direct a second current through cylinder liner 28 (Step 170). The second current may be similar to or different from the first current. Current generating device 42 may harden different sections of a metal component to different degrees of hardness.

Similar to the first current, current generating device 42 may heat cylinder 28 to a temperature of between about 1,420° F. to 1,450° F. in less than about one second with the second current. As current generating device 42 is relocated through cylinder liner 28 by actuator 60, and as long as current generating device 42 does not reach the end of lower section 38 of cylinder 28 (Step 180—No), controller 54 will continue to direct current generating device 42 to direct the second current through cylinder liner 28. Upon arrival of current generating device 42 at the end of lower section 38 of cylinder liner 28 (Step 180—Yes), controller 54 may cause current generating device 42 to stop directing the second current through cylinder liner 28 (Step 190).

Temperature sensor 45, travel sensor 47 and a timer (not shown) may be in communication with, and provide feedback data to, controller 54. Controller 54 may adjust the actions of actuator 60, and or current generating device 42, based on the feedback signals and/or data controller 54 receives from temperature sensor 45, travel sensor 47 and the timer. For example, temperature sensor 45 may communicate to controller 54 that the temperature of cylinder liner 28 is 100° below the hardening temperature. In response, controller 54 may direct actuator 60 to slow the movement of cylinder liner 28 past current generating device 42.

In some embodiments, middle section 36 of cylinder 28 may remain unhardened. In others, however, middle section 36 may be hardened by the same process described above or with a different process that includes additional hardening steps. One example of an additional hardening step may be a laser hardening step. The laser hardening step may include directing a laser to make multiple passes or closed helical passes over the surface of middle section 36. The laser hardening step may occur before or after the upper section 34 and lower section 38 have been induction hardened.

The disclosed system and method may yield a hardened cylinder liner 28 in a time and energy efficient manner. The entire upper section (upper bore) and entire lower section (lower bore) may be induction hardened in the above-described discontinuous induction hardening process. The middle section (port relief area) of cylinder liner 28 may be laser hardened. The laser hardening process may occur before or after the induction hardening process.

By automating the process, as disclosed in exemplary method 100, the induction hardening of a cylindrical metal component may be more consistently and accurately performed relative to a system dependent upon human laborer participation. The induction hardening process, as disclosed in exemplary method 100, may utilize less energy than other hardening methods. For example, traditional ovens and furnaces may require 10 to 100 times more energy to operate. Additionally, while generally effective at whole component heating, ovens and furnaces cannot be used to heat only some sections of a component.

It will be apparent to those skilled in the art that various modifications and variations can be made to the disclosed hardening system without departing from the scope of the disclosure. Other embodiments of the hardening system will be apparent to those skilled in the art from consideration of the specification and practice disclosed herein. It is intended that the specification and examples be considered as exemplary only, with a true scope of the disclosure being indicated by the following claims and their equivalents.

What is claimed is:

1. A system for hardening a cylindrical metal component, comprising:
a current generating device configured to pass current through the cylindrical metal component in an annular direction to heat the cylindrical metal component;
an actuator configured to axially move the current generating device through the cylindrical metal component; and
a controller in communication with the current generating device and the actuator, the controller being configured to:
cause the actuator to move the current generating device through the cylindrical metal component in a generally continuous manner;
cause the current generating device to pass current through a first end section of the cylindrical metal component to heat the first end section of the cylindrical metal component above a desired first hardening temperature as the current generating device moves through the first end section of the cylindrical metal component;
inhibit the current generating device from passing current through a middle section of the cylindrical metal component as the current generating device moves through the middle section of the cylindrical metal component; and
cause the current generating device to pass current through a second end section opposite the first end section of the cylindrical metal component to heat the second end section of the cylindrical metal component above a desired second hardening temperature as the current generating device moves through the second end section of the cylindrical metal component.

2. The system of claim 1, wherein the cylindrical metal component includes a cast iron cylinder liner.

3. The system of claim 1, wherein at least a portion of the cylindrical metal component is hardened to a hardness greater than approximately 50 on the Rockwell C scale.

4. The system of claim 1, further including a water nozzle configured to deliver water to the cylindrical metal component following the induction heating of the cylindrical metal component to quench the heated cylindrical metal component.

5. The system of claim 1, wherein the actuator further includes an apparatus configured to spin the cylindrical metal component during the induction heating and quenching of the cylindrical metal component to uniformly heat and cool the cylindrical metal component.

6. The system of claim 1, wherein the current generating device heats the first and second sections of the cylindrical metal component to a first hardening temperature of at least 1,420° F. in less than about 1 second.

7. The system of claim 1, further including a temperature sensor configured to sense a temperature of the cylindrical metal component as the cylindrical metal component is being heated.

8. The system of claim 7, wherein the controller is in communication with the temperature sensor and is configured to adjust the action of the actuator in accordance with signals from the temperature sensor.

9. The system of claim 1, further including a travel sensor, wherein the controller is in communication with the travel sensor, and is configured to track a distance traveled by the current generating device through the cylindrical metal component.

10. The system of claim 9, wherein the controller is further configured to adjust action of the actuator in accordance with signals from the travel sensor.

11. The system of claim 1, further including a timer, wherein the controller is in communication with the timer, and is configured to track the amount of time that the current generating device is heating the cylindrical metal component.

12. The system of claim 11, wherein the controller is further configured to adjust action of the actuator in accordance with signals from the timer.

13. A method of hardening a cylindrical metal component, comprising:
directing a current generating device axially through the cylindrical metal component in a generally continuous manner;
causing the current generating device to pass current through the cylindrical metal component as the current generating device moves axially through a first end section of the cylindrical metal component to heat the first end section above a desired first hardening temperature;
inhibiting the current generating device from passing current through the cylindrical metal component as the current generating device moves axially through a middle section of the cylindrical metal component; and
causing the current generating device to pass current through the cylindrical metal component as the current generating device moves axially through a second end section of the cylindrical metal component to heat the second end section above a desired second hardening temperature.

14. The method of claim 13, further including sensing a temperature of the cylindrical metal component as the cylindrical metal component is heated.

15. The method of claim 14, further including adjusting action of the actuator in accordance with the sensed temperature.

16. The method of claim 13, further including sensing a distance traveled by the current generating device as the current generating device moves through the cylindrical metal component.

17. The method of claim 16, further including adjusting action of the actuator in accordance with the distance traveled.

18. The method of claim 13, further including tracking a time of operation of the current generating device as it heats the cylindrical metal component.

19. The method of claim 18, further including adjusting action of the actuator in accordance with the time of operation.

20. The method of claim 13, further including laser hardening a middle section in between the first and second end sections of the cylindrical metal component.
